(19) United States
(12) Patent Application Publication
(10) Pub. No.: US 2023/0092467 A1
(43) Pub. Date: Mar. 23, 2023

(54) AUTOMATA PROCESSING METHOD AND APPARATUS FOR REGULAR EXPRESSION ENGINES USING GLUSHKOV AUTOMATA GENERATION AND HYBRID MATCHING

(71) Applicant: UIF (University Industry Foundation), Yonsei University, Seoul (KR)

(72) Inventors: Yo Sub HAN, Seoul (KR); Joong Hyuk HAHN, Seoul (KR); Si Cheol SUNG, Chuncheon-si, Gangwon-do (KR)

(73) Assignee: UIF (University Industry Foundation), Yonsei University, Seoul (KR)

(21) Appl. No.: 17/521,156

(22) Filed: Nov. 8, 2021

(30) Foreign Application Priority Data
Sep. 23, 2021 (KR) 10-2021-0125933

(51) Int. Cl. G06N 5/04

(52) U.S. Cl. CPC G06N 5/047

(57) ABSTRACT

Provided are an automata processing method and apparatus capable of transforming a regular expression pattern into a specific type of nondeterministic finite automata (NFA), selectively applying a matching algorithm to the nondeterministic finite automata according to whether to include an extended grammar to minimize the use of temporal and spatial resources, and preventing regular expression denial of service (ReDoS).

### ACKNOWLEDGEMENT

The present patent application has been filed as research projects as described below.

National Research Development Project supporting the Present Invention

Project Serial No. 1711126002

Project No. 2018-0-00276-004

Department: Ministry of Science and ICT

Project management (Professional) Institute: Institute of Information & Communication Technology Planning & Evaluation

Research Project Name: Information & Communication Broadcasting Research Development Project

Research Task Name: Development of original technology for deep learning-based automated malignant code pattern rule set generation (4/5)

Contribution Ratio: 1/2

Project Performing Institute: Yonsei University Industry Foundation

Research Period: 2021.01.01˜2021.12.31

National Research Development Project supporting the Present Invention

Project Serial No. 1711126082

Project No.: 2020-0-01361-002

Department: Ministry of Science and ICT

Project management (Professional) Institute: Institute of Information & Communication Technology Planning & Evaluation

Research Project Name: Information & Communication Broadcasting Research Development Project

Research Task Name: Artificial Intelligence Graduate School Support Project (2/5)

Contribution Ratio: 1/2

Project Performing Institute: Yonsei University Industry Foundation

Research Period: 2021.01.01˜2021.12.31

### CROSS-REFERENCE TO PRIOR APPLICATION

This application claims priority to Korean Patent Application No. 10-2021-0125933 (filed on Sep. 23, 2021), which is hereby incorporated by reference in its entirety.

### BACKGROUND

The present disclosure relates to relates to a nondeterministic finite automata processing method and apparatus.

The content described in this background section merely provides background information for the present embodiment and does not constitute the related art.

The regular expression is a formal language used to express a set of character strings with specific rules. It is often used to express the character string to be found when comparing or searching for character strings in computing devices including computers.

Regular expressions are based on epsilon (c), which means a character string with no contents, and regular expressions composed of only one character (e.g., a, b, c, etc.), and character strings of various patterns may be expressed by combining basic regular expressions using operators such as concatenation (abc, bbbb, baba, etc.), selection (ablc, ablba, etc.), and repetition (c*, etc.).

Since the regular expression may become too long or complex, for convenience of use, there is also a regular expression in the form of adding various extended grammars.

### RELATED ART DOCUMENT

### Patent Document

(Patent Document 1) WO 2012-133976 (2012 Oct. 4)
(Patent Document 2) U.S. Pat. No. 9,563,399 (2017 Feb. 7)
(Patent Document 3) KR 10-1222486 (2013 Jan. 16)
(Patent Document 4) KR 10-1645890 (2016 Oct. 5)

### SUMMARY

The present disclosure provides transform a regular expression pattern into a specific type of nondeterministic finite automata (NFA), selectively apply a matching algorithm to the nondeterministic finite automata according to whether to include an extended grammar to minimize a use of spatial and temporal resources, and provide regular expression engines robust against regular expression denial of service (ReDoS) attacks.

Other objects not specified in the present disclosure may be additionally considered within the scope that can be easily inferred from the following detailed description and effects thereof.

In an aspect, an automata processing method by an automata processing apparatus includes: a step of generating a specific type of nondeterministic finite automata based on a regular expression pattern; and a matching step of checking an acceptance path for a character string with respect to the nondeterministic finite automata.

The step of generating the nondeterministic finite automata may include transforming each node to correspond to one character.

The step of generating the nondeterministic finite automata may include transforming the regular expression pattern into a Glushkov automata according to a Glushkov construction.

The regular expression pattern may be expressed as a regular expression or an extended regular expression, and the extended regular expression may be applied with an extended grammar including a capture group, a dereference, a forward search, or a combination thereof. The matching step may selectively apply a first matching algorithm or a second matching algorithm according to whether the regular expression pattern corresponds to the extended regular expression.

In the matching step, the first matching algorithm may be applied in which when the regular expression pattern includes the extended grammar, a path is searched by selecting one of several next states that moves through each character starting from a starting state, an unselected state is separately stored along with a position on the character string, when there is an acceptance path among paths progressed in a state selected first, matching is terminated, and when the acceptance path is not searched, a new path is searched based on a most recently stored state and position.

In the matching step, the second matching algorithm may be applied in which when the regular expression pattern does not include the extended grammar, all the next states that move through each character starting from the starting state are simultaneously considered, and when a current state includes an acceptance state at a time when all characters are consumed, it is determined that there is the acceptance path.

In another aspect, an automata processing apparatus includes: a processor; and a memory for storing a program executed by the processor, in which the processor generates a specific type of nondeterministic finite automata based on a regular expression pattern, and performs matching to check an acceptance path for a character string with respect to the nondeterministic finite automata.

The processor may generate the nondeterministic finite automata by transforming each node to correspond to one character.

The processor may transform the regular expression pattern into a Glushkov automata according to a Glushkov construction to generate the nondeterministic finite automata.

The regular expression pattern may be expressed as a regular expression or an extended regular expression, and the extended regular expression may be applied with an extended grammar including a capture group, a dereference, a forward search, or a combination thereof.

The processor may perform the matching by selectively applying a first matching algorithm or a second matching algorithm according to whether the regular expression pattern corresponds to the extended regular expression.

The processor may apply the first matching algorithm in which when the regular expression pattern includes the extended grammar, a path is searched by selecting one of several next states that moves through each character starting from a starting state, an unselected state is separately stored along with a position on the character string, when there is an acceptance path among paths progressed in a state selected first, matching is terminated, and when the acceptance path is not searched, a new path is searched based on a most recently stored state and position.

The processor may apply the second matching algorithm in which when the regular expression pattern does not include the extended grammar, all the next states that move through each character starting from the starting state are simultaneously considered, and when a current state includes an acceptance state at a time when all characters are consumed, it is determined that there is the acceptance path.

As described above, according to the embodiments of the present disclosure, it is possible to transform a regular expression pattern into a specific type of nondeterministic finite automata (NFA), selectively apply a matching algorithm to for the nondeterministic finite automata according to whether to include an extended grammar to minimize the use of temporal and spatial resources, and prevent regular expression denial of service (ReDoS).

Even if it is an effect not explicitly mentioned herein, the effects described in the following specification expected by the technical features of the present disclosure and their potential effects are treated as if they were described in the specification of the present disclosure.

### BRIEF DESCRIPTION OF THE DRAWINGS

FIG. 1 is a block diagram illustrating an automata processing apparatus according to an embodiment of the present disclosure.

FIG. 2 is a diagram illustrating a Thomson automaton including an extended grammar.

FIG. 3 is a diagram illustrating a Glushkov automaton including an extended grammar processed by the automata processing apparatus according to the embodiment of the present disclosure.

FIG. 4 is a diagram illustrating the Glushkov automaton including the extended grammar processed by the automata processing apparatus according to the embodiment of the present disclosure.

FIGS. 5A to 5C are diagrams illustrating results of applying a Spencer algorithm to the Thomson automaton of FIG. 2 in a tree form.

FIG. 6 is a diagram illustrating a process of checking character string match by applying the Spencer algorithm to the Glushkov automaton of FIG. 3.

FIGS. 7A to 7C are diagrams illustrating results of applying the Spencer algorithm to the Glushkov automaton of FIG. 3 in a tree form.

FIGS. 8A to 8C are diagrams illustrating results of applying the Spencer algorithm to the Glushkov automaton of FIG. 4 in the tree form.

FIG. 9 is a diagram illustrating a process of checking character string match by applying a classical matching algorithm to the Glushkov automaton of FIG. 4.

FIGS. 10A to 10C are diagrams showing results of applying the classical matching algorithm to the Glushkov automaton of FIG. 4 in a tree form.

FIG. 11 is a flowchart illustrating an automata processing method according to another embodiment of the present disclosure.

### DETAILED DESCRIPTION

Hereinafter, in the description of the present disclosure, if it is determined that the subject matter of the present disclosure may be unnecessarily obscured as it is obvious to those skilled in the art with respect to related known functions, the detailed description thereof will be omitted, and some embodiments of the present disclosure will be described in detail with reference to exemplary drawings.

When a service provider using regular expression engines uses a harmful regular expression pattern, the engine may be used as a vehicle for a Denial of Service (DoS) attack. This is called regular expression denial of service (ReDoS). The ReDoS occurs because temporal and spatial resources required for the engine to check whether a harmful pattern and a character string match are excessively (exponentially) large compared to a length of the character string. Many existing programs use the regular expression engines, and thus, are exposed to the risk of the ReDoS attacks.

In the present specification, new regular expression engines that require less temporal and spatial resources than the conventional method are proposed. It is possible to check regular expression pattern match faster, and write more stable programs.

The automata processing apparatus according to the present embodiment applies a classical matching algorithm to fundamentally block the ReDoS, and even when it is necessary to use a Spencer algorithm for a regular expression to which the extended grammar is applied, Glushkov automata may help prevent the ReDoS.

The automata processing apparatus according to the present embodiment generates a nondeterministic finite automata (NFA) corresponding to a Glushkov automata, and selectively applies a Spencer algorithm or a classical matching algorithm according to whether to include an extended grammar.

The regular expression pattern processed by the automata processing apparatus according to the present embodiment means a pattern of a character string expressed by a regular expression or an extended regular expression. The regular expression engines are used to check whether a regular expression pattern matches a character string, which includes an NFA creation process that creates a nondeterministic finite state automaton (NFA) corresponding to a regular expression pattern, and a matching process that checks whether the NFA has an acceptance path for character strings.

The automata processing apparatus transforms a regular expression pattern into a Glushkov automata, an NFA that is efficient for matching, during the NFA generation process. A hybrid matching process that selectively applies the Spencer algorithm and the classical matching algorithm according to a regular expression pattern is performed. As compared with the prior art using the Thompsons automata and the Spencer algorithm, the regular expression pattern match may be checked in a shorter time.

Any character σ is a regular expression, and (r₁ r₂), (r₁|r₂), (r₁′) is also a regular expression for the regular expressions r₁ and r₂. The language L(r) represented by the regular expression r is defined as follows.

L(σ)={σ} (1)

L(r₁r₂)=L(r₁)L(r₂) (2)

L(r₁|r₂)=L(r₁)∪L(r₂) (3)

L(r₁*)=L(r₁)* (4)

The regular expression defined in this way may extend its grammar by utilizing the concepts of capturing group, dereferencing, and forward search for real-life applications.

Depending on the use of the regular expressions, the regular expressions may be called regular expression patterns or patterns.

A capture group (ₙ)ₙ and a dereference \n are used when you want to reuse a partial character string that is matched as part of a regular expression. The capture group stores a sub-character string matched by a regular expression inside the group, and the backreference matches a sub-character string stored in the capturing group. For example, when (₁ab|ba)1\1 is matched with abab, the capture group (₁)₁ checks that ablba matches first ab of abab and stores ab. Thereafter, the dereference \1 refers to the ab stored by the capture group (₁)₁, and matches the ab at the back of abab. Similarly, the pattern matches abab and baba, but in abba and baab, the character string referenced by the backreference is different from the character string that is actually trying to match. That is, the pattern (₁ab|ba)1\1 does not match the character strings of the abba and baab.

The forward search (?=) is used only to determine whether a first part of the character string that will appear later matches the pattern inside the forward search, and does not actually match. For example, in the pattern a(?=b)(a|b)*, (?=b) is the forward search, and the pattern inside the forward search is b. When the pattern a(?=b)(a|b)* is matched to aba, after matching the a in the pattern and the a in the character string, the forward search (?=b) determines whether the first part of the remaining character string, ba, matches the regular expression b. After the forward search checks this, it does not actually match, so the regular expression (a|b)* at the rear part tries to match ba, not the character string a. Since these two match, the entire pattern a(?=b)(a|b)* matches the entire character string aba. Similarly, the pattern matches aba and abb. On the other hand, the character string such as aab or aaa does not match b in the forward search (?=b), and therefore, does not match the entire pattern a(?=b)(a|b)*.

The capture group, the dereference, the forward search, etc. are called the extended grammar, and regular expressions including them are called extended regular expressions. The present disclosure is a regular expression engine that supports extended regular expressions and efficiently determines the match between a character string and a regular expression pattern.

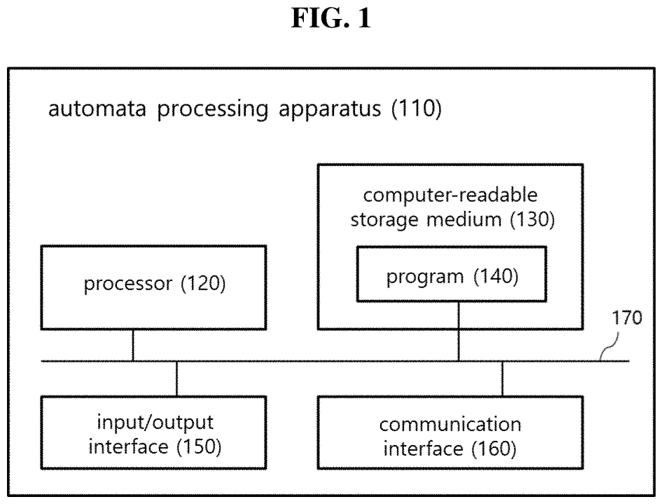

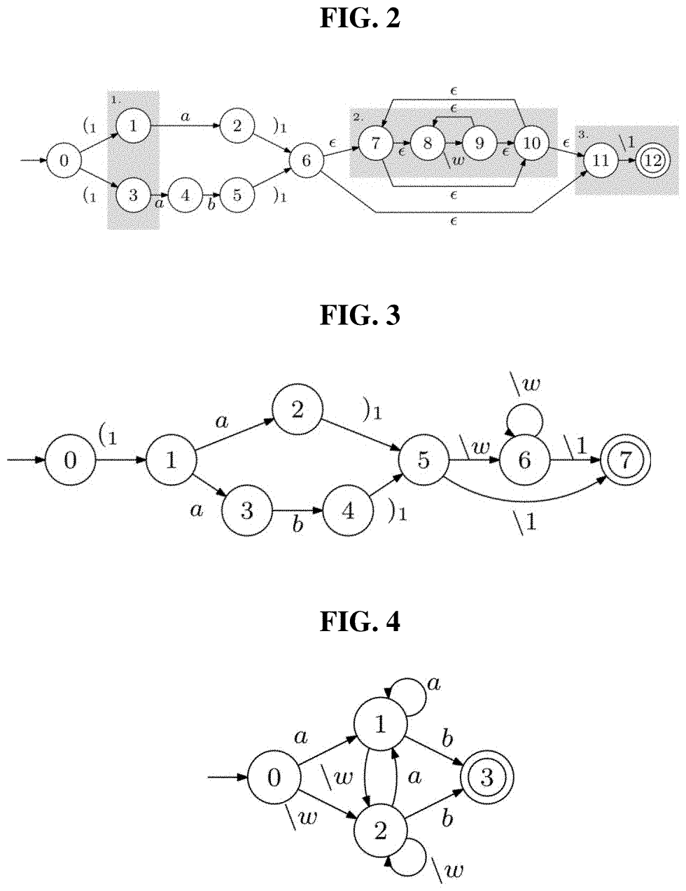

FIG. 1 is a block diagram illustrating an automata processing apparatus according to an embodiment of the present disclosure. FIG. 2 is a diagram illustrating a Thomson automaton including an extended grammar, FIG. 3 is a diagram illustrating a Glushkov automaton including an extended grammar processed by the automata processing apparatus according to the embodiment of the present disclosure, and FIG. 4 is a diagram illustrating the Glushkov automaton including the extended grammar processed by the automata processing apparatus according to the embodiment of the present disclosure.

The automata processing apparatus 110 includes at least one processor 120, a computer-readable storage medium 130, and a communication bus 170.

The processor 120 may control to operate as the automata processing apparatus 110. For example, the processor 120 may execute one or more programs stored in the computer-readable storage medium 130. The one or more programs may include one or more computer executable instructions, which, when executed by the processor 120, computer-executable instructions may be configured to cause the automata processing apparatus 110 to perform operations according to the exemplary embodiment.

The computer-readable storage medium 130 is configured to store computer-executable instructions or program code, program data, and/or other suitable form of information. The computer-executable instructions or program code, program data, and/or other suitable form of information may also be provided via an input/output interface 150 or a communication interface 160. The program 140 stored in the computer-readable storage medium 130 includes a set of instructions executable by the processor 120. In one embodiment, the computer-readable storage medium 130 includes a memory (volatile memory such as random access memory, non-volatile memory, or a suitable combination thereof), one or more magnetic disk storage devices, optical disk storage devices, flash memory devices, other types of storage media accessed by the automata processing apparatus 110 and capable of storing desired information, or a suitable combination thereof.

The communication bus 170 interconnects various other components of the automata processing apparatus 110, including the processor 120 and the computer readable storage medium 130.

The automata processing apparatus 110 may also include one or more input/output interfaces 150 and one or more communication interfaces 160 that provide interfaces for one or more input/output devices. The input/output interface 150 and the communication interface 160 are connected to the communication bus 170. The input/output device (not illustrated) may be connected to other components of the automata processing apparatus 110 through the input/output interface 150.

The automata processing apparatus generates the NFA called Glushkov automata for patterns for efficient match check of the extended regular expressions, and the match check is a hybrid matching algorithm that uses an efficient algorithm according to a given regular expression pattern among the classical matching algorithm and the Spencer algorithm. The automata processing apparatus performs the processes of generating the NFA for the core regular expression pattern and checking the match between the pattern and the character string.

The processor generates a specific type of nondeterministic finite automata based on the regular expression pattern, and performs the matching to check an acceptance path for the character string with respect to the nondeterministic finite automata.

The processor may generate the nondeterministic finite automata by transforming each node to correspond to one character. The processor may generate the nondeterministic finite automata by transforming the regular expression pattern into the Glushkov automata according to Glushkov construction.

The process of generating the NFA transforms the regular expression patterns into the NFA. The regular expression pattern may be expressed as a regular expression or an extended regular expression, and the extended regular expression may be applied with an extended grammar including a capture group, a dereference, a forward search, or a combination thereof. The NFA is generated using the Glushkov construction for the given regular expression pattern. The NFA generated through the Glushkov construction are called the Glushkov automata.

Referring to FIG. 3, the Glushkov automaton for the extended regular expression (₁a|ab)₁(\w*)*\1 is illustrated. Referring to FIG. 4, the Glushkov automaton for the regular expression pattern (a|\w)*b without the extended grammar is illustrated. In this case, \w is a special character that matches all alphabets.

The matching process checks whether the character string is matched or not when the character string is given.

The process of checking the match of the character string to the regular expression pattern is called the matching process. To this end, using the generated NFA, it checks if there is a path to reach the acceptance state by consuming all the characters of the corresponding character string in sequence in the starting state of the NFA.

When receiving the character string aab in FIG. 4, the NFA starts from 0, which is the start state, reads a, and proceeds to state 1. It reads the next character a, and goes back to state 1, reads the last character b, and goes to state 3, which is an accepted state. The path is called the path for the character string, and there may be more than one path depending on the situation.

Among the paths of the character string, the path that reaches the acceptance state is called the acceptance path. When there is the acceptance path, the regular expression pattern and the character string match, otherwise the pattern and the character string do not match.

In this embodiment, one of the following two algorithms is selected and applied according to whether the regular expression pattern includes the extended grammar. Compared to the Spencer algorithm, the classical matching algorithm has a smaller variance in execution time, but there are cases where it cannot be applied to the regular expression extended grammar (e.g., dereferencing, forward search). Therefore, the Spencer algorithm is applied to the extended regular expression.

The processor may perform the matching by selectively applying a first matching algorithm or a second matching algorithm according to whether the regular expression pattern corresponds to the extended regular expression. The first matching algorithm may correspond to the Spencer algorithm, and the second matching algorithm may correspond to the classical matching algorithm.

The processor may apply the first matching algorithm in which when the regular expression pattern includes the extended grammar, a path is searched by selecting one of several next states that moves through each character starting from a starting state, an unselected state is separately stored along with a position on the character string, when there is an acceptance path among paths progressed in a state selected first, matching is terminated, and when the acceptance path is not searched, a new path is searched based on a most recently stored state and position.

The processor may apply the second matching algorithm in which when the regular expression pattern does not include the extended grammar, all the next states that move through each character starting from the starting state are simultaneously considered, and when a current state includes an acceptance state when all characters are consumed, there is the acceptance path.

The existing engines (e.g., JAVA, Python, etc.) are based on Thompson automata and apply a method of recursively generating NFAs for characters and operators in expressions. This has the advantage that the form of the NFA is intuitive and simple to implement, but has an edge that does not consume characters, which is an inefficient form for performing match determination.

Referring to FIG. 2, a Thompson automaton corresponding to the same regular expression as in FIG. 3 is illustrated. That is, FIG. 2 illustrates the Thompson automaton when the extended grammar is included. Some nodes are omitted for readability.

The present embodiment is based on the Glushkov automata, where each node corresponds to one character. As a result, more than one node appearing in the Thompson automaton is abbreviated to one node in the Glushkov automaton.

A specific example of such abbreviation can be confirmed through the abbreviation of the nodes of regions 1, 2, and 3 indicated by a rectangle in the Thompson automaton of FIG. 2 to nodes 1, 6, and 7 in the Glushkov automaton of FIG. 3, respectively.

The NFA may have several next states corresponding to a specific input symbol. ε corresponds to a symbol that means that the length of the string is 0 and is called epsilon.

The ε transformation means that there is a state which may see E. State transition is possible even if no input symbol is received.

Glushkov construction has no e-transformation. The starting state has no inner transformation. All inner transformations of each state have the same label. The number of states is one more than the number of symbols in the regular expression.

The Glushkov construction may be obtained by repeatedly applying four functions, null, first, last, and follow, which are defined recursively according to the type of regular expression.

Referring to A. Bruggemann-Klein, “Regular expressions into finite automata”, Theoretical Computer Science, 1993, contents on Glushkov automata generation may be confirmed.

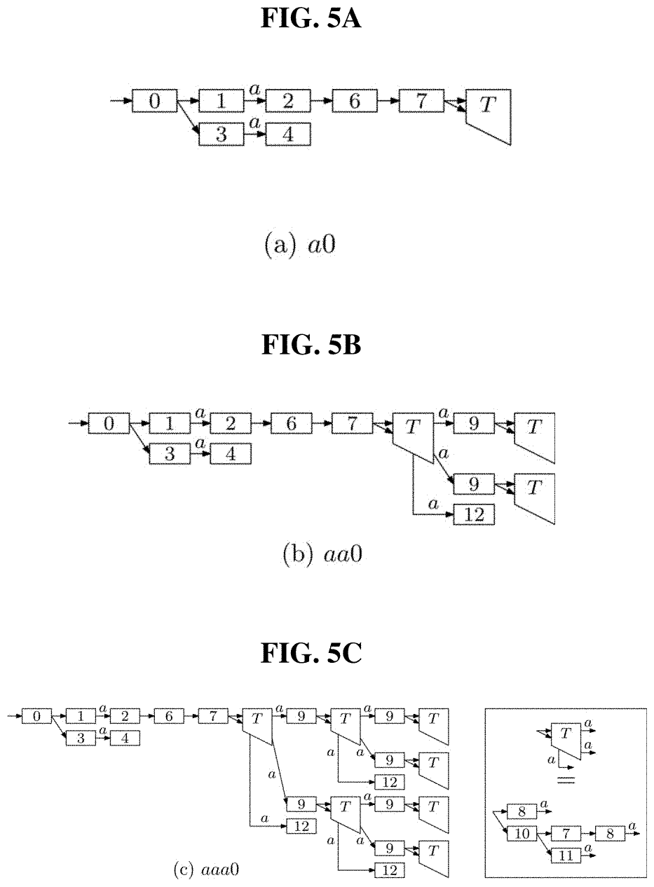

FIGS. 5A to 5C are diagrams illustrating results of applying a Spencer algorithm to the Thomson automaton of FIG. 2 in a tree form.

After generating the NFA from the pattern, the existing engines may perform matching based on the Spencer algorithm in the matching process. The feature of searching all paths of the Spencer algorithm is essential to support the extended grammar, but otherwise, it results in duplicate confirmation of common parts in multiple paths.

Referring to FIG. 5, the results of performing the Spencer algorithm on the character strings (a) ab, (b) aab, (c) aaab on the Thompson automaton including the extended grammar are expressed in tree form, respectively, and the observations show that the Thompson automaton exhibits an exponential increase in match check time, which is the cause of the ReDoS.

A specific example in which the Spencer algorithm repeatedly searches the same path may be confirmed by repeating the process indicated by T in FIGS. 5A to 5C. That is, it is possible to confirm the occurrence of ReDoS in the conventional Thomson automaton and Spencer algorithm due to the harmful pattern including the extended grammar.

The present embodiment prevents this by using the Classical matching algorithm when the extended grammar is not used.

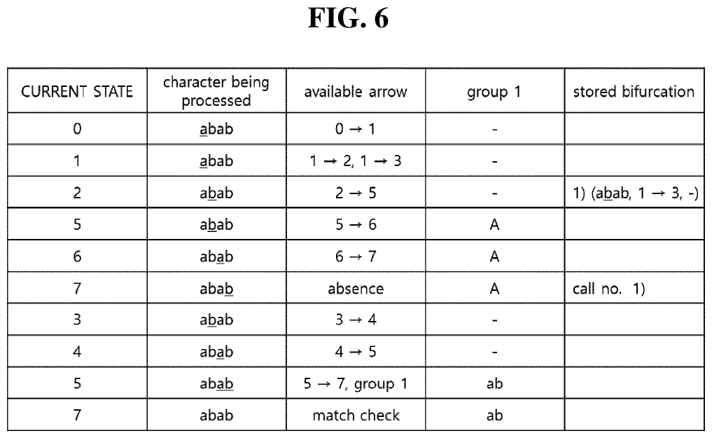

FIG. 6 is a diagram illustrating a process of checking character string match by applying the Spencer algorithm to the Glushkov automaton of FIG. 3.

When the regular expression includes the extended grammar, the matching is performed using the Spencer algorithm. The algorithm searches for a path by starting from the starting state and selecting one of several next states that may move through each character. In this case, the unselected state is stored separately along with the position on the character string. When there is an acceptance path among the paths progressed in the first selected state, the matching is terminated. When the acceptance path is not found, a new path is searched based on the most recently stored state and position.

Referring to FIG. 6, it may be seen a process of confirming the match with the character string abab based on the NFA including the extended grammar.

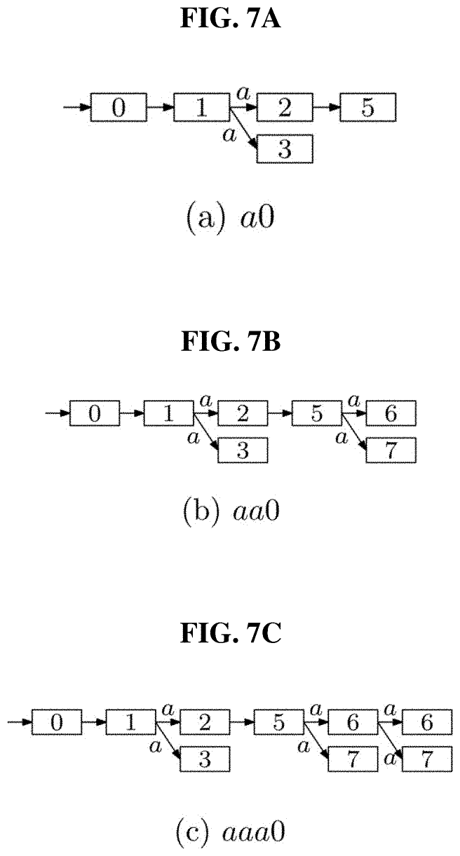

FIGS. 7A to 7C are diagrams illustrating results of applying the Spencer algorithm to the Glushkov automaton of FIG. 3 in a tree form.

FIG. 7 illustrates what was performed in the Glushkov automaton including the extended grammar, and it may be seen that the exponential increase in the match check time does not appear in the Glushkov automaton. Both automatons illustrated in FIGS. 2 and 3 are NFAs corresponding to regular expression pattern (₁a|ab)₁(\w*)*\1 including the extended grammar, and in the related art, a pattern that was harmful is not harmful in the present embodiment. That is, it may be confirmed that the harmfulness of the pattern is resolved through the Glushkov automaton.

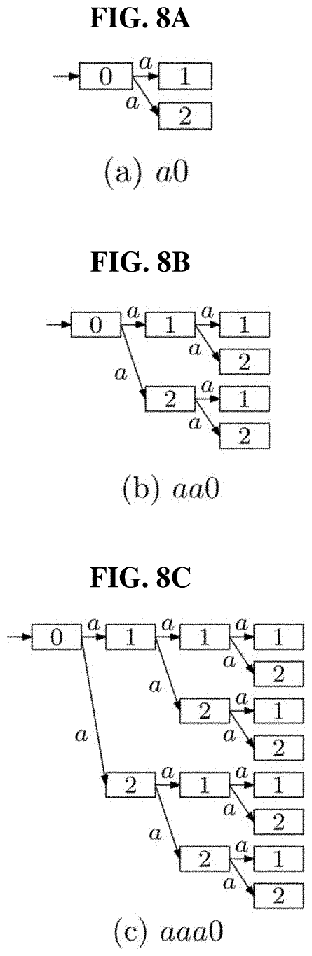

FIGS. 8A to 8C are diagrams illustrating results of applying the Spencer algorithm to the Glushkov automaton of FIG. 4 in the tree form.

Referring to FIG. 8, the result of performing the Spencer algorithm on character strings (a) ab, (b) aab, (c) aaab is expressed in the Glushkov automaton that does not include the extended grammar, and the observations show that there is an exponential increase in match confirmation time, which is the cause of the ReDoS. That is, it is possible to check the occurrence of the ReDoS due to the harmful patterns that do not include the extended grammars.

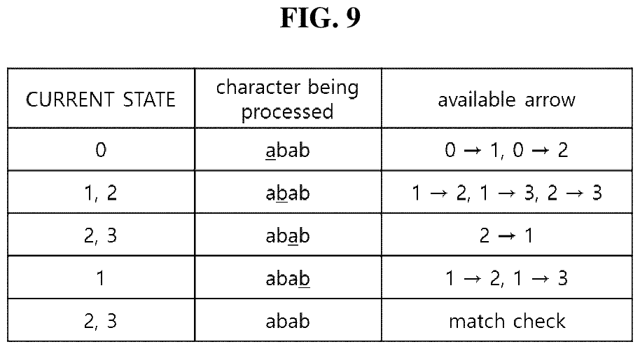

FIG. 9 is a diagram illustrating a process of checking character string match by applying a classical matching algorithm to the Glushkov automaton of FIG. 4.

When the regular expression does not include the extended grammar, the Classical matching algorithm is used. The algorithm starts from the starting state and simultaneously considers all the next states that may move through each character. When the current state includes the acceptance state at the time all characters are consumed, it is determined that there is the acceptance path.

Referring to FIG. 9, a process of confirming the match with abab based on the NFA that does not include the extended grammar may be confirmed.

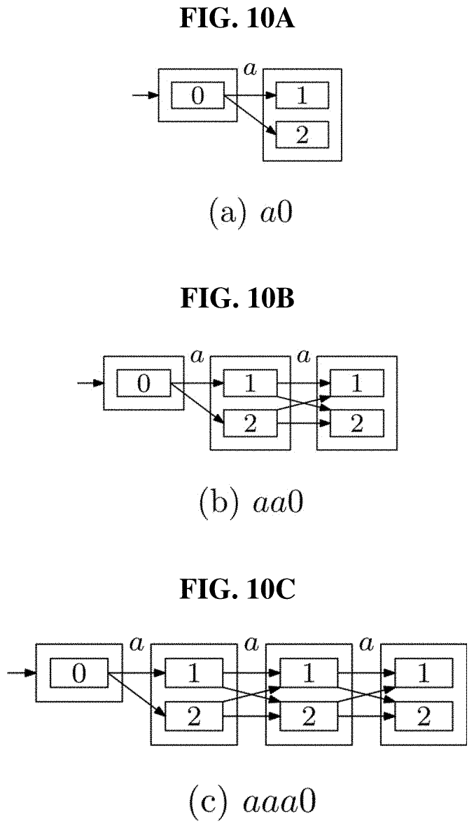

FIGS. 10A to 10C are diagrams showing results of applying the classical matching algorithm to the Glushkov automaton of FIG. 4 in a tree form.

The results of performing the Classical matching algorithm on the automaton and the character string that do not include the extended grammars are illustrated. Through this, it may be confirmed that the Classical matching algorithm blocks the exponential increase in the matching time. That is, it may be confirmed that the harmfulness of the pattern may be resolved through the classical matching.

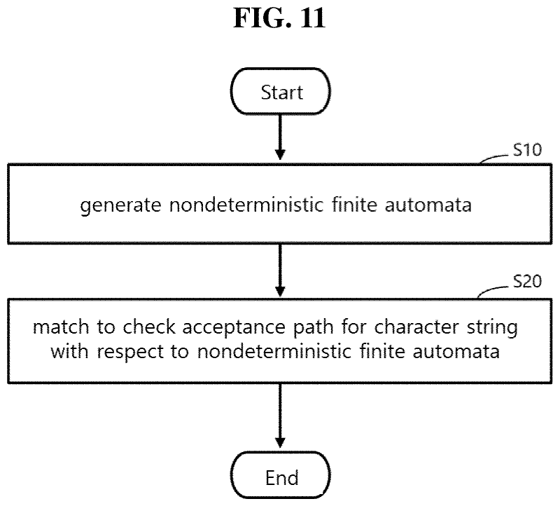

FIG. 11 is a flowchart illustrating an automata processing method according to another embodiment of the present disclosure.

The automata processing method may be performed by the automata processing apparatus.

In step S10, a specific type of nondeterministic finite automata is generated based on the regular expression pattern.

In step S20, the matching is performed to confirm the acceptance path for the character string for the nondeterministic finite automata.

In the step (S10) of generating the nondeterministic finite automata, each node may be converted to correspond to one character. In the step (S10) of generating the nondeterministic finite automata, the regular expression pattern may be converted into the Glushkov automata according to the Glushkov construction.

The regular expression pattern may be expressed as a regular expression or an extended regular expression, and the extended regular expression may be applied with an extended grammar including a capture group, a dereference, a forward search, or a combination thereof.

In the matching step, the first matching algorithm or the second matching algorithm may be selectively applied according to whether the regular expression pattern corresponds to the extended regular expression.

In the matching step (S20), the first matching algorithm may be applied in which when the regular expression pattern includes the extended grammar, a path is searched by selecting one of several next states that moves through each character starting from a starting state, an unselected state is separately stored along with a position on the character string, when there is an acceptance path among paths progressed in a state selected first, matching is terminated, and when the acceptance path is not searched, a new path is searched based on a most recently stored state and position.

In the matching step (S20), the second matching algorithm may be applied in which when the regular expression pattern does not include the extended grammar, all the next states that move through each character starting from the starting state are simultaneously considered, and when a current state includes an acceptance state at a time when all characters are consumed, it is determined that there is the acceptance path.

The automata processing apparatus may be implemented in a logic circuit by hardware, firmware, software, or a combination thereof, and may be implemented using a general-purpose or special-purpose computer. The device may be implemented using a hardwired device, a field programmable gate array (FPGA), an application specific integrated circuit (ASIC), or the like. In addition, the device may be implemented as a system on chip (SoC) including one or more processors and controllers.

The automata processing apparatus may be mounted in the form of software, hardware, or a combination thereof on a computing device or server provided with hardware elements. A computing device or server may mean various device including all or part of a communication device such as a communication modem for performing communication with various devices or wired/wireless communication networks, a memory for storing data for executing a program, a microprocessor for executing the program to perform calculations and commands, etc.

Although it is described that each process is sequentially executed in FIG. 11, this is only an exemplary description, and those skilled in the art may apply various modifications and variations by changing the order described in FIG. 11 or executing one or more processes in parallel or adding other processes without departing from the essential characteristics of the embodiments of the present disclosure.

Exemplary embodiments of the present disclosure may be implemented in a form of program commands that may be executed through various computer means and may be recorded in a computer-readable recording medium. The computer-readable medium represents any medium that participates in providing instructions to a processor for execution. The computer-readable media may include program instructions, data files, data structures, or a combination thereof. For example, there may be a magnetic medium, an optical recording medium, a memory, and the like. A computer program may be distributed over a networked computer system so that computer readable code is stored and executed in a distributed manner. Functional programs, codes, and code segments for implementing the present disclosure may be easily inferred by programmers in the art to which the present disclosure belongs.

The present disclosures are for explaining the technical idea of the present disclosure, and the scope of the technical idea of the present disclosure is not limited by these disclosures. The scope of the present disclosure should be interpreted by the following claims, and it should be interpreted that all the spirits equivalent to the following claims fall within the scope of the present disclosure.

What is claimed is:

1. An automata processing method by an automata processing apparatus, comprising:
a step of generating a specific type of nondeterministic finite automata based on a regular expression pattern; and
a matching step of checking an acceptance path for a character string with respect to the nondeterministic finite automata.

2. The automata processing method of claim 1, wherein the step of generating the nondeterministic finite automata includes transforming each node to correspond to one character.

3. The automata processing method of claim 1, wherein the step of generating the nondeterministic finite automata includes transforming the regular expression pattern into a Glushkov automata according to a Glushkov construction.

4. The automata processing method of claim 1, wherein the regular expression pattern is expressed as a regular expression or an extended regular expression, and the extended regular expression is applied with an extended grammar including a capture group, a dereference, a forward search, or a combination thereof.

5. The automata processing method of claim 4, wherein the matching step selectively applies a first matching algorithm or a second matching algorithm according to whether the regular expression pattern corresponds to the extended regular expression.

6. The automata processing method of claim 5, wherein in the matching step, the first matching algorithm is applied in which when the regular expression pattern includes the extended grammar, a path is searched by selecting one of several next states that moves through each character starting from a starting state, an unselected state is separately stored along with a position on the character string, when there is an acceptance path among paths progressed in a state selected first, matching is terminated, and when the acceptance path is not searched, a new path is searched based on a most recently stored state and position.

7. The automata processing method of claim 5, wherein in the matching step, the second matching algorithm is applied in which when the regular expression pattern does not include the extended grammar, all the next states that move through each character starting from the starting state are simultaneously considered, and when a current state includes an acceptance state at a time when all characters are consumed, it is determined that there is the acceptance path.

8. An automata processing apparatus, comprising:
a processor; and
a memory configured to store a program executed by the processor,
wherein the processor generates a specific type of nondeterministic finite automata based on a regular expression pattern, and performs matching to check an acceptance path for a character string with respect to the nondeterministic finite automata.

9. The automata processing apparatus of claim 8, wherein the processor generates the nondeterministic finite automata by transforming each node to correspond to one character.

10. The automata processing apparatus of claim 8, wherein the processor transforms the regular expression pattern into a Glushkov automata according to a Glushkov construction to generate the nondeterministic finite automata.

11. The automata processing apparatus of claim 8, wherein the regular expression pattern is expressed as a regular expression or an extended regular expression, and the extended regular expression is applied with an extended grammar including a capture group, a dereference, a forward search, or a combination thereof.

12. The automata processing apparatus of claim 11, wherein the processor performs the matching by selectively applying a first matching algorithm or a second matching algorithm according to whether the regular expression pattern corresponds to the extended regular expression.

13. The automata processing apparatus of claim 12, wherein the processor applies the first matching algorithm in which when the regular expression pattern includes the extended grammar, a path is searched by selecting one of several next states that moves through each character starting from a starting state, an unselected state is separately stored along with a position on the character string, when there is an acceptance path among paths progressed in a state selected first, matching is terminated, and when the acceptance path is not searched, a new path is searched based on a most recently stored state and position.

14. The automata processing apparatus of claim 12, wherein the processor applies the second matching algorithm in which when the regular expression pattern does not include the extended grammar, all the next states that move through each character starting from the starting state are simultaneously considered, and when a current state includes an acceptance state at a time when all characters are consumed, it is determined that there is the acceptance path.
